(19) United States
(12) Patent Application Publication
(10) Pub. No.: US 2002/0181044 A1
(43) Pub. Date: Dec. 5, 2002

(54) Method and system using holographic methodologies for all-optical transmission and reception of high bandwidth signals to and from end-users to serve video, telephony and internet applications

(76) Inventor: Jacob L. Kuykendall JR., Sudbury, MA (US)

Correspondence Address: McDERMOTT, WILL & EMERY, 28 State Street, Boston, MA, 02109-1775, US

(21) Appl. No.: 09/953,029

(22) Filed: Sep. 14, 2001

Related U.S. Application Data
(60) Provisional application No. 60/232,309, filed on Sep. 14, 2000.
(60) Provisional application No. 60/232,550, filed on Sep. 14, 2000.
(60) Provisional application No. 60/232,254, filed on Sep. 14, 2000.
(60) Provisional application No. 60/232,307, filed on Sep. 14, 2000.

(51) Int. Cl. H04B 10/08; H04J 14/02

(52) U.S. Cl. 359/124; 359/110

(57) ABSTRACT

An optical transmission system includes a plurality of service provider systems providing transmission-based services; a plurality of end-user devices receiving transmission-based services and a central hub node including a first plurality of terminals for supporting bi-directional transmission of optical signals between the plurality of service provider systems and the central hub node and a second plurality of terminals for supporting bi-directional transmission of optical signals between the end-user devices and the central hub node. The system further includes a first transmission network coupled between the plurality of service provider systems and the plurality of first terminals of the central hub node for enabling the bi-directional transmission of optical signals between the plurality of service provider systems and the plurality of first terminals of the central hub node and a second transmission network coupled between the plurality of end-user devices and the plurality of second terminals of the central hub node for enabling the bi-directional transmission of optical signals between the plurality of end-user devices and the plurality of first terminals of the central hub node. The bidirectional optical transmission between each of the plurality of end-user devices and the central hub node occurs at a dedicated wavelength that is unique to each end-user device.

### CROSS REFERENCES TO RELATED APPLICATIONS

This application claims the benefit of priority from commonly owned U.S. Provisional Patent Application Serial No. 60/232,309, filed Sep. 14, 2000; U.S. Provisional Patent Application Serial No. 60/232,550 filed Sep. 14, 2000; U.S. Provisional Patent Application Serial No. 60/232,254 filed Sep. 14, 2000; and U.S. Provisional Patent Application Serial No. 60/232,307, filed Sep. 14, 2000.

### FIELD OF THE INVENTION

The present invention relates to fiber optic networks, and more particularly to end-user networks including local loops and metropolitan applications.

### BACKGROUND OF THE INVENTION

The fiber based end-user markets and sub markets have been referred to by many names including, but not limited to, fiber-to-the-home (FTTH), fiber-to-the-building (FTTB), fiber-to-the-office (FTTO), fiber-to-the-small business (FTTSB), fiber-to-the-desk (FTTD), fiber-to-the-office park (FTTOP), fiber-to-the-school (FTTS), fiber-in-the-local loop (FITLL) and fiber-to-the-wireless base station (FTTWBS). For purposes of discussing the areas that will be addressed by the present invention, all above-mentioned applications will be referred to as fiber-to-the-end-users (FTTEU) applications

To justify deploying all optic technology for the end-user markets, significant cost advantages and technological enhancements must be possible to offset the cost and effort required to replace of the legacy copper and coaxial systems with fiber. Up to now, telephone and CATV initiated solutions developed to increase bandwidth have been based on retrofitting and enhancing the installed systems; thus preserving the significant investment in both the installed copper telephone plant and CATV coaxial-based distribution networks that have evolved with the growth of the industries. Fiber has been installed in the high capacity trunks, extending to within a mile or two of the end-users for both telephone and CATV service thus employing hybrid networks. To extend bandwidth for the first and last mile, the current telephony technologies include ADSL (asynchronous digital subscriber line) for the copper plant and cable modems for CATV systems.

Optical fiber-based networking technology has been successfully implemented for long distance and citywide or metropolitan voice and data and video applications, significantly increasing bandwidth and at the same time reducing costs. Though the same optical fiber systems could technically serve end-user applications, they have not proven to be cost effective relative to the historic low bandwidth copper or coaxial cable systems. The low bandwidth copper and coaxial local loops are now the bottlenecks of voice, data and video networks. Current all-optic passive fiber networks serving end-users utilize splitter technologies that are based on sharing a single bandwidth with multiple end-users, requiring complex bandwidth sharing allocation and management protocols.

Current art end-user gateways, known as SOHO gateways, for small businesses and small office/home office customers, current address this market, but at low data rates of 1 to 5 Mb/s, due primarily to limitations of current art copper and coaxial networks and are of limited utility for high data rate services. Despite the low bandwidth capabilities of current art SOHO gateways, the designs have been comprehensive to interface to industry standard communications terminal devices such as local area networks (LANS), IP based telephony systems, PC's, fax machines, television sets, video recorders, home security/alarm systems, electrical appliances, utility meters and closed circuit TV cameras. Typically, gigabit Ethernet can be expected to be utilized as the end-user network protocol of choice when end-user network data rates are installed to support such transmission speeds.

Gigabit level SOHO gateways have not been developed, even though the components exist to build them, because there are not gigabit level end-user networks to allow their widespread use. Examples of currently available inexpensive optical networking chip sets and single chips that deliver up to 10 Gb/s are the AMCC S3097/S3098 that can be used as the primary processing modules for the end-user gateway modules. Similarly, single chip Ethernet units are available such as SACS LAN91C111 that provides single chip solutions for 10/100/1000 Base T Ethernet and the PMC-Sierra s/UNI-10GE. As the next generation end-user all-optic market develops, competition in the end-user and SOHO gateway market can be expected to drive gateway unit costs down to levels of $100 or less. For business or industrial end-users, the gateways will also include interfaces to LANs that serve PCs, networked mini and mainframe computers, video systems, bank teller machines supermarket and store cash registers systems, gas station pumps, and street lighting monitor and control.

A technical challenge for optical networks serving local loop applications has been in the ability to provide power at the end-user location to insure continued service during power outages that can match the reliability level that currently exists with basic telephone service. With current art, talk power for phone systems is provided by the central office, using banks of battery storage systems and delivered over copper to the end-user locations.

High bandwidth networks serving such applications as wireless base station connections to mobile switching centers and corporate host computer center connections to data storage areas are now typically served by dedicated or VPN networks using circuit switched network standards including T1, DS 3 and SONET based OC-48 or OC-192. 10 GB/s service using SONET (OC-192) now costs ten times more than 10 GB/s service using Gigabit Ethernet, and with the proper networking infrastructure, 10 GB Ethernet could serve mobile base station applications.

Although fiber-to-the-end-user technology has the potential to provide significant improvements in bandwidth a end users at low costs, incumbent local exchange phone companies and CATV companies have been lax in developing and deploying this technology, in-part because it would render obsolete the copper and coaxial local loop delivery systems that are the majority of their asset base prior to the economic life of such systems. There is disincentive to obsolete their asset base with a replacement technology that has significant cost and no driving competitive pressure to do so.

National and state governments as well as major municipal governments are currently establishing programs to fund the development and installations of a fiber based local networking infrastructure to provide optical bandwidth to end-users. These initiatives are similar to those that prompted the Rural Electrification Administration (REA) development for rural areas electrification programs for areas that were not financially attractive investments for private development. These government-sponsored programs in effect offset the lack of incentives by incumbent copper based service providers to introduce FTTEU systems.

### SUMMARY OF THE INVENTION

The present invention addresses each of the limitations of copper, coaxial and hybrid fiber with copper and coaxial FTTEU systems cited above. To solve the current art bandwidth limitations, the present invention allows dedicating wavelengths to each end-user, thus enabling multi-gigabit data rates to and from each end-user, and at the same time eliminating the complexity and cost of bandwidth sharing associated with local loop systems. The significant advantage of the present invention is in the ability to increase the bandwidth to an end-user by several hundred or even thousand fold compared to ADSL, coaxial modems or ISDN and at the same time significantly reducing the cost to levels below current local loop levels.

One aspect of the invention includes a method for delivering optical channels of bandwidths in the general range of from 2 to 5 GHz, with channel spacing of from 0.01 to 0.03 nm, to and from a central hub and multiple end-user locations at a distance of typically up to 25 miles, utilizing a system consisting of a holographic-based dense wave division multiplexer/demultiplexer module that is configured in a distributed, cascaded arrangement of two or more stages, the cascaded modules deployed between the central hub location and the end-user location, that utilizes a an optical tree fiber network configured as a logical star network permanently connecting one or more dedicated unique wavelength for each end-user at the points of the star.

The method may further include constructing the optical tree network with a modular distributed dense wave division multiplexer system configured to carry typically 10,000 multi-gigabit channels to and from a hub location, using L, C, S bands and spectrum outside of the conventional ITU bands, with the cascaded modules of a distributed DWDM located at each branch of the tree, connected by fibers that carry multiple channels between the hub location and a second cascaded dense wave division multiplexer module, a next fiber segment connecting the second and a third cascaded dense wave division multiplexer module and a dedicated fiber or fiber pair between the third stage and the end-user, carrying at least two wavelengths to the end-user. The method may further include delivering nominally up to 10,000 wavelengths to and from up to 10,000 end-user locations within a radius of approximately 25 miles, comprising low insertion loss dense wave division multiplexer cascaded network modules, having narrow channel spacing of a high channel count stage of the mux/de-mux module and an optical feed back system to lock channel power laser sources. The method may further include collecting and distributing optical traffic in a geographical local service area utilizing dedicated wavelengths for each of a plurality of end-users, and providing bandwidths of nominally 2.0 to 5 GHz, by performing one of modulation from 1 Gb/s up to 5 Gb/s, using non-return-to zero modulation and up to 10 Gb/s using bandwidth efficient modulation.

Another aspect of the invention includes a method for configuring an access network consisting of a high channel capacity star network with a dedicated wavelength delivered to each of a plurality of end-users at points of the star, implemented over an all-optical fiber tree configuration with distributed dense wave division multiplexer modules located at each branch of the tree, the network serving as an optical local loop distribution network, to accommodate delivery of all telecommunications services between a central hub location and end-users within a radius of typically 25 miles.

Another aspect of the invention includes an improved optical local network comprising strategically located end-points to form virtual optical networks for purposes of serving multi-gigabit data rate channels for carrying IP or other transport protocol-based mobile base station traffic, dropping and inserting mobile traffic bandwidth to serve wireless base transmit sites that are dispersed throughout the end-user serving area, utilizing similar systems as are residential end-users or business end-users, and appear as virtual private networks.

The improved optical local network may be utilized for carrying geographically dispersed servers, disks and automated tape libraries for purposes of transferring files for storage

Another aspect of the invention includes an improved method for generating and delivering pump power for Raman and Erbium Doped Fiber amplifiers, through combining laser power sources through a holographic beam combiner, combining power on the same wavelengths or on a family of dissimilar wavelengths to achieve “flat” power profiles of desired output levels, and delivering the power to a fiber transmission facility through ports on the same DWDM systems that carry information channels.

Another aspect of the invention includes an improved method for generating and delivering channel carrier laser power to a fiber transmission facility, through holographic power combining techniques.

Another aspect of the invention includes an improved method for creating large laser power combining facilities, to be used on multiple fibers for multiple star network configurations, both as pump power sources and as shared per channel power sources.

Another aspect of the invention includes an improved method for providing carrier laser power to an end-user location, from a central hub location.

Another aspect of the invention includes an improved method for providing first and second order power to a Raman amplifier located in the return path of a fiber transmission facility, serving multiple end-users through a shared Raman amplifier facility.

According to another aspect of the invention, an optical transmission system includes:

a plurality of service provider systems providing transmission-based services;

a plurality of end-user devices receiving transmission-based services;

a central hub node including a first plurality of terminals for supporting bidirectional transmission of optical signals between the plurality of service provider systems and the central hub node and a second plurality of terminals for supporting bidirectional transmission of optical signals between the end-user devices and the central hub node;

a first transmission network coupled between the plurality of service provider systems and the plurality of first terminals of the central hub node for enabling the bidirectional transmission of optical signals between the plurality of service provider systems and the plurality of first terminals of the central hub node; and

a second transmission network coupled between the plurality of end-user devices and the plurality of second terminals of the central hub node for enabling the bi-directional transmission of optical signals between the plurality of end-user devices and the plurality of first terminals of the central hub node;

wherein the bi-directional optical transmission between each of the plurality of end-user devices and the central hub node occurs at a dedicated wavelength that is unique to each end-user device.

The second transmission network may include a demultiplexer system for demultiplexing each optical signal transmitted from the plurality of second terminals of the central hub node into a plurality of the dedicated wavelength optical signals unique to each of the plurality of end-user devices. The system second transmission network may include a multiplexer system for multiplexing each of the plurality of the dedicated wavelength optical signals unique to each of the plurality of end-user devices to optical signals transmitted to the plurality of second terminals of the central hub node. The transmission-based services provided by the plurality of service providers may include at least one of telephone services, video broadcast services, internet services and data transmission services. Each of the end-user devices may include one of a home and business, each including a conversion device for converting the dedicated wavelength optical signal to an electrical signal which utilized by a data device associated with the one of a home and business. Each conversion device may further convert electrical signals from the data device to optical signals having the dedicated wavelength for transmission to the central hub node. The second transmission network may include at least one intermediate node between the central hub node and the plurality of end-user devices. The at least one intermediate node may include a first node located approximately 0 to 5 miles from each end-user device and a second node located between the first node and the central hub node and wherein the central hub node is located up to 25 miles from each end-user device. The bidirectional transmission of optical signals between the plurality of end-user devices and the plurality of first terminals of the central hub node may occur in a bandwidth having a range of approximately 2 GHz to 10 GHz. The central hub node may include a power pump for providing power to the first and second transmission networks.

### BRIEF DESCRIPTION OF THE DRAWINGS

The invention is pointed out with particularity in the claims forming the concluding portion of the specification. The invention, both as to its organization and manner of operation, may be further understood by reference to the following description taking in connection with the following drawings:

Of the Drawings:

FIG. 1 is a schematic diagram of a prior art local loop communications network serving end-users with services including telephone, cable TV distribution, Internet and other end-user based services;

FIG. 2a is a schematic diagram of the multi-functional integrated passive optic, fiber based system serving end-users, showing all elements between typical end-user locations and the central hub location utilizing the present invention;

FIG. 2b is a schematic diagram of a typical fiber to the end-user network showing three levels of multiplexing/de-multiplexing showing a logical wavelength star, implemented on a physical optical tree network;

FIG. 3 is a schematic diagram of the end-user gateway arrangement for a typical end-user installation;

FIG. 4 is a schematic diagram of the hub arrangement, showing the interface to service provider regional networking facilities;

FIG. 5 is a schematic diagram of passive optical multiplexer units showing dedicated wavelengths corresponding to one for each end-user, configured to typically serve 10,000 end-users, located in the hub;

FIG. 6 is a schematic diagram of passive distributed optical de-multiplexer with the first stage at a central hub, the second stage typically located in a town or community center and the third stage typically installed in the street between the town center and the end-user location;

FIG. 7 is a schematic diagram of distributed passive optical multiplexer units showing dedicated wavelengths for carrying optical signals from end-users to the town center or community center and to the third stage at a central hub;

FIG. 8 is a schematic diagram of optical de-multiplexer units showing dedicated wavelengths corresponding to one for each end-user, configured to typically serve 10,000 end-users located at the hub location;

FIG. 9 is a schematic diagram of a prior art wireless network utilizing land telephone networking technology to interconnect the base transmit sites to mobile switching centers;

FIG. 10 is a schematic diagram of an—all-optic core network with dedicated wavelength per cell site using a star network configuration;

FIG. 11—is a schematic diagram of a prior art -typical major company storage area network configuration utilizing enterprise disk storage;

FIG. 12—is a schematic diagram of a typical all-optic network storage area network configuration utilizing remotely located enterprise disk storage;

FIG. 13—is a schematic diagram of a prior art Raman amplifier pump power arrangement;

FIG. 14—is a schematic diagram of an HBC based Raman amplifier with multiple pump wavelengths to affect wide gain in one and both directions;

FIG. 15—is a schematic diagram of a pump power arrangement for EDFA, first and second order Raman amplifiers;

FIG. 16—is a schematic diagram of a networking arrangement for delivering second and first order Raman amplifier pump power at the remote end user location; and

FIG. 17—is a schematic diagram of a pump power delivery system serving multiple fibers at multiple power bands over a common facility driving EDFA and Raman amplifiers.

### DESCRIPTION OF THE PREFERRED EMBODIMENTS

To address the system prowering requirements, the present invention employs a centralized optical powering technique by locating the laser power sources for each channel and for network pump power for EDFA and Raman amplifiers at the central hub, thus requiring no network supplied power outside of the central hub.

To serve specific applications now employing separate dedicated networks, the present invention can be configured to serve as a dedicated bandwidth connection capable of carrying 10 Gigabit Ethernet (or higher), and will better serve the needs of applications such as mobile base station to switching center and host to data storage applications at costs similar to end-user residential service costs. The present invention makes available dedicated bandwidth connections as virtual private networks (VPN) utilizing ports within an end-user serving area on the same system serving residential end-users.

From a business prospective, this invention's local optical bandwidth distribution model is similar to the distribution methodology now used for the delivery of electric power, whereby a single utility is responsible for the delivery of electrical power to the end-users, but the generation of power is delegated to competitive regional generation utilities. Though telecommunications services and related switching and networking are more complex than electrical power and requires more intelligent and sophisticated systems to manage, switch and meter the services, such telecommunications switching, management and metering systems currently exist and are available and complimentary to the present invention. Given the similarities between delivering electric power and optical bandwidths, the body of state and federal regulations governing power distribution could be expanded to serve as the model for distribution end-user bandwidth as well.

From an optical bandwidth infrastructural development prospective, the present invention is an ideal networking model for being deployed through government funded programs that can better serve public interests than current copper based utilities. As the network is protocol and service independent, it can serve many independent service providers that will not be required to operate the optical distribution network reaching end users. As such, end-users will enjoy true competition between services providers that will result in the lowest possible cost for high data rate services.

Briefly stated, in accordance with the present invention, the end-user is served by a fiber-optic network that extends from the demarcation point within the home or office directly to a central concentration/distribution location (central hub node), typically up to 25 miles away, with a dedicated wavelength for each end-user. The inherent distance design criteria of this invention far exceed the local loop distances necessary for both urban and rural installations.

Typically, two intermediate concentration/distribution nodes exist between the end-user location and the central hub, one in the street typically within one to five miles of the end-user and one within the town or community that is typically up to five miles from the street concentration node. A typical town or community will then have a single fiber pair connection to the central hub location.

Though there is extreme flexibility in the ultimate design of this system, for discussion purposes a typical configuration of 6,000 end-user channels of 3.75 Ghz for each channel is considered for illustration. This example utilizes current art fiber bandwidths and the current ITU designated L, C and S bandwidth windows. For this example, the bandwidth windows are; 1) the L band between 1610 nm and 1580 nm, 2) the C band between 1580 and 1530 and 3) the S band between 1350 and 1450. With 0.03 nm channel spacing the combined bandwidth windows the three bands equaling 170 nm will result in 5,666 channels of 3.75 GHz each. By increasing the thickness of the holographic material used in the construction of the DWDM of this invention, and operating as a reflective hologram, channel spacing can be reduced to 0.02 nm and the bandwidth of each channel drops to 2.5 GHz, resulting in an increase in the number of possible channels to 8,500. With the present invention, additional channels may be derived from areas above the L band and below the S band. If Raman amplifiers only are used, avoiding the current art limiting bandwidth restrictions of the EDFA amplifiers that limit use within the C and L bands only, additional bandwidth becomes available. As the photopolymer material (PMMA/PDA) utilized in describing an embodiment of this invention operates between 488 nm and 2000 nm, the channel limitations are imposed by the intrinsic scattering and the intrinsic absorption of the fiber media and the commercial availability of laser sources at the various wavelengths. As ongoing developments both in fiber construction, such as using hollow fiber addressing current art fiber limitations and solves the scattering and absorption limitations, and in laser development extending to currently unused portions of the spectrum, with continued fiber and laser development the full capabilities of the present invention will be realized.

To serve larger installations such as major metropolitan areas, this design can be scaled up by implementing multiple systems, re-using the frequency plan for each system and implementing each system within a different geographical area. For illustrative purposes, a distributed DWDM three stage cascaded configuration is discussed with the cascading arrangement with 25×20×20 or 10,000 wavelengths handled by a single system. The channel count can be scaled up or down as an example, by increasing the channels of any of the cascaded modules. For example, if 25×25×20 were used, the total channel count will be 12,500 wavelengths.

Unlike DSL or cable modem solutions that are distance limited, the present invention can serve end-users within the 25-mile local serving area, made possible by the low insertion loss of the optical components and the remote Raman amplifier powering methodology described herein. The present invention requires that the pump power that drives the optical network be present only at the central node. At the end-user locations, signal modulation power only is required, from diode laser sources similar in cost and power to those found in CD players, with the local electrical power derived from the end-users home gateway system. The optical network design of the present invention is passive, avoiding the need for active pump power sources in the streets or in the case sited above, at the remote location. This design saves in installation and maintenance costs, improves reliability and eliminates optical networking equipment failure due to loss of local power. Of course, the end-user electrical power sources that are independent of the optical network will need to be provided by the end-user, with appropriate back up.

In a typical FTTEU application, the network design is a virtual star configuration with dedicated wavelengths to each end-user, implemented over a tree bi-directional fiber network, with typical two-way dedicated bandwidth to each end-user in the range of 2 to 10 Ghz. Ten GHz is not an upper limit, as the system could be configured to deliver the full bandwidth of the fiber to any end-user, which is in the tens of THz range. Conversely, 2 Ghz is not the lower limit, as the holographic channelization units can be constructed to deliver narrower bandwidths by increasing the thickness of the first stage holographic DWDM elements.

The photo polymer material PDA that is used in an embodiment of this invention operates over the bandwidth of 488 nm to 2000 nm, thus a wide range of wavelength windows can be used, including the traditional L, C and S bands wavelengths as well as bandwidth in between and outside of these bands. By utilizing the wide bandwidth holographic-based DWDM coupled with Raman amplifiers that also operate over the full spectrum of 488 to 2000 nm, the present invention avoids the bandwidth limitations that are inherent in EDFA powered networks that are limited to operate in the L and C bands only. With the present invention, the constraints are therefore governed primarily by the dB losses of the fiber and the fiber amplifiers and not the cascaded holographic DWDM networking elements.

The network architecture is a star network with a dedicated λ for traffic between the hub to end-user and a dedicated λ for traffic between the end-user to the hub. The physical fiber network is a tree configuration. A typical design will allocate a physical fiber pair between the end-user and the first concentration node; however, the system design allows a single fiber to be configured to carry traffic in both directions by positioning the up-stream and down-stream traffic on separate bands within the fiber, providing redundancy. The distance between the hub and the end user is typically 25 miles, made possible by the low insertion loss of the holographic-based cascaded DWDM system and the novel method used for powering Raman amplifiers. The 25-mile distance is not an upper limit, and could be extended through optimizing the network design.

An example of a specific application is in creating a virtual private network (VPN) by utilizing selected end-user ports for use as a network to carry high data rate channels between one or more mobile base station sites and mobile switching centers. With a deployed fiber network with ports capable of delivering two way, multi-gigabits of bandwidth, selected ports from in-the-street DWDM modules located in the vicinity of a mobile base station site can be used to carry traffic back to the central hub, where the λ is directed as a dedicated channel to the mobile switching center. Costs to provide the service will be of the same order of magnitude as costs to provide port connection to a residential end-user, in the order of $50 to $100 per month, depending upon the system amortization schedule that is utilized. In comparison, current cost for multi-gigabit service from LECs or private network providers is several thousand dollars per month per end point, if it is available.

In a similar manner, providing multi-gigabit dedicated channels for the transfer of high data volumes to serve storage network requirements can be accomplished through point-to-point connections configured as multi-gigabit dedicated channels to make up VPN storage networks. By using distance insensitive bus technology such as Infiniband over dedicated λs that serves both internal and external connections of host computers, host and storage servers may operate at 4 Gb/s at unlimited distances, the current data rate and distant limitations of fiber channel-based technology can be avoided. For interconnection of the data storage devices and host computers located within the same local end-user serving area, such connections can be made through cross connecting optical channels at the hub location. If one or more of the storage or host devices are located outside of the local end-user storage area, in a different local end-user storage area, the remote units may be connected through actual or virtual optical channels obtained from long distance bandwidth providers, using industry standard protocols such as 1 or 10 Gigabit Ethernet.

The transition from circuit-based voice switching technology to Internet Protocol (IP) based technology has begun, with the industry acceptance of high quality packetized voice operating over local and long distance fiber networks with high Quality of Service. The trend of phone companies is to replace legacy class 5 central office systems with large scale “soft switches” that emulate the circuit switch functions, provide both circuit and IP-based switching and translate between the two technologies. The present invention enhances this process by bringing end-user fiber based traffic to a single concentration point within a major market area (the hub), where optical IP-based telephone service will be carried from the end-users as point-to-point traffic as one of the multiple services. Through large scale IP-to-circuit switched gateways, located at the hubs, interfaces can effectively be made on a regional level, (class 4 circuit switched basis), as opposed to a local level (class 5 switched basis) as a more cost effective means for interfacing between the old and new technologies. As copper circuit based class five central offices are eventually replaced with fiber-based IP telephony service, the fiber-based infrastructure of the present invention will serve the total needs of the end-user. In making the switchover there will be no disruption or degradation of service through the transition process even though the two technologies will be required to operate in parallel during the transition phases.

Installing fiber local loop networks offer the potential for superior services to end-users, however there is significant cost for installing the services and there is no clear cut charter of which organization should make the investment and operate the all-fiber networks; the legacy local exchange carriers (LECs) or the cable TV (CATVs) providers. Although a fiber-to-the-end-user infrastructure can serve all end-user networking requirements, including phone service, video services and high data rate Internet, the LECs have historically not provided CATV services and the CATV companies have not, on a wide scale, provided basic phone service. The end result is that neither of these wire service-based industries has aggressively developed fiber-to-the-end-user fiber services, even though such development could have significant benefit to their customers.

National, state and municipal governments have recognized this inherent lack of incentive on the part of LECs and CATV companies, and have begun establishing local pilot access fiber infrastructure develop programs, and are funding the programs through public sources. Canada, Sweden, Iceland, Holland, the State of Oregon, the City of Chicago and the City of Alberta, are recent examples. The programs are being implemented without well-established networking and channelization designs that allow the current art fiber networks to be economically deployed and provisioned for use by multiple application service providers. The protocol agnostic all-fiber end-user networking infrastructure of the present invention has been designed to serve independent service providers. The architecture of the present invention ideally lends itself to be financed and operated with public funding. Service providers for voice, video services, Internet and other end-user services could then be competitively selected.

Delivering pump power to a fiber transmission facility currently is done through power splitters, with from 4 to 6 sources combined with spacing between laser sources limited to 1 nm. The present invention allows inserting laser sources with spacing as narrow as 0.03 nm, thus allowing a flatter output of the combined sources and greater power outputs, since a larger number of sources can be used. Additionally, the power can be inserted into one or more ports of the same DWDM as is used for signal channels, and the DWDM can be constructed to direct power both upstream and downstream.

A key component of the all-optic fiber network of this invention will be the laser sources for each channel of the system. As the most reliable design encompasses locating all pump power and signal source lasers at the hub location, the laser source facility will of prime importance. Locating the laser sources at the central hub location will have significant positive reliability and maintenance ramifications, since the laser sources can be reliably powered, monitored and replaced in the event of failure with a minimum of manpower resources and no travel time.

For metropolitan areas that require multiple systems, of typically 10,000 channels each, common laser power sources can be assembled that serve multiple 10,000 channel systems. By using multiple combined laser power modules for each individual λ that is used within a single hub location, the reliance on a single laser diode source will be avoided and the cost for a multi-laser system serving multiple end-users (with the same λ) will be less than one source for each end-user.

The system design of the present invention specifies that first and second order Raman amplifier pump power and per λ signal source power be located at the central hub location. A typical channel assignment plan will be to designate the S band to carry modulated signals that go from the hub to the end user, and L and C bands for traffic that originates at the end-user locations. In this scheme, an unmodulated unique λ with a carrier signal in the L and/or C band will then be sent to each end-user, to be looped back and modulated by the end-user's local gateway system, that carries information designated for the various services provider systems. Modulation signal only is required from the end-user location, which is provided by the individual sub-systems within the end-user location and managed by the end-user gateway system.

Lumped Raman or fiber Raman amplifiers are located upstream from the in-the-street mux/demux node, to provide power needed for the typically 25 end-users that are handled by the in-the-street node. Raman amplifier pump power is supplied from the hub location, with first order power sent on the return fiber (from the end-user to the hub) and second order power sent on the outgoing fiber (from the hub to the end-user). At the in the-street mux/demux location, second order pump power is extracted from the hub-to-end-user fiber and inserted into the end-user-to-hub fiber via the DWDM module, where it powers the Raman amplifier from the end-user side of the circuit. Depending upon the fiber utilized, a fiber dedicated to carrying Raman power may be required between the hub location and the node upstream from the in-the-street node, serving typically 20 Raman amplifier units.

The town/community nodal unit will be located to serve as the concentrator for the in-the-street nodes. At this location, single fiber carries multiple dedicated wavelengths to a central node, typically located in the center of a town or community. The central node is the location where all town/community nodes are interconnected, at the hub of the star network. The connections are dedicated on optical fiber from the in-the-street nodes to the home and are dedicated wavelengths sharing a fiber from the in the-street nodes to the central node, passing through typically one additional concentration node. The system utilizes a passive design, requiring no active amplifiers between the central node and the end-user, a distance of typically up to 25 miles. At the central node, the various services of each end-user are separated through wavelength multiplexing. As the network design is protocol agnostic, the application and service providers may then utilize any standard protocol for managing the end-user services, such as Gigabit Ethernet, IP, TDMA, MPEG 2 or 4 and various others used for monitoring and management services.

The network model of the present invention serves both similar and disparate user needs through industry standard transmission protocols and protocol converters. An example of the residential and business applications served by this invention that can share the common end-user fiber network through the end-user collection stage of the DWDM is a home network, a business, an office complex, a high capacity mobile base station, a computer data center, a data storage facility or computer host systems located in an Internet hotel.

This arrangement affords the ultimate in open access as each end-user has the choice of any service provider for each of the services that are available from the multiple providers. Switching services from one service provider to another will require on-line customer initiated service request changes only, thus the response to end-user can be rapid and without the need for on-site service calls. By unbundling the local network ownership from the ownership of the services provided, the end-user will enjoy the maximum benefit of true competition between the various service providers. At the same time, the open access design of the present invention will not inhibit the introduction of new networking technologies that have been the weakness of past-regulated monopolies. The present invention will be the first network design in history that will provide end-users the ability to dynamically choose any one of multiple service providers including local phone service, CATV programming, Internet services based on the wishes and direct action of the end-users. This affords the end-user the ultimate in open access.

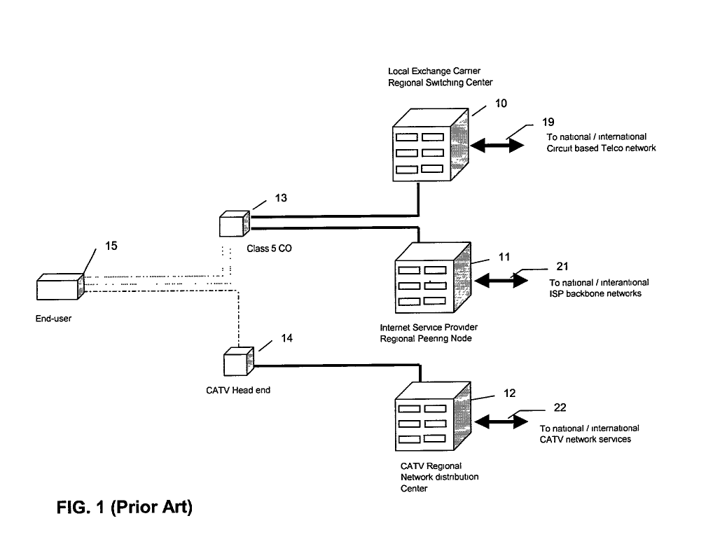

FIG. 1 is a schematic diagram of a typical end-user network connection, being served by traditional service providers including a local phone company 10, cable TV company 12, Internet service provider 11 and specialized alarm and monitoring services provided as telephone based services. Local phone companies typically utilize copper pair wiring that extends from the demarcation box, placed within the end-user location 15. Video services are typically provided via coaxial cable, terminating on a demarcation box, and wired to a set-top box within the home or business structure 15. Internet connections are currently made in four ways, a) through a dial-up modem that utilized a conventional telephone line, b) through a dedicated copper wire connection that utilized a technology known as digital subscriber line (DSL) through telephone line facilities, c) through a cable TV (CATV) provided connection over the coaxial cable networks utilizing cable modems, and d) through a satellite connection that delivers down stream data to the user and employs a telephone modem for the up-stream connection. Alarm and monitoring services typically utilize telephone provided dedicated leased circuits to connect users to alarm and monitoring service providers. High capacity circuit connections between the telephone company central office 13 and the Regional Switching Center 10 is typically via optical circuits. Similarly, the high capacity circuit connections between the CATV company Head ends 14 and the CATV regional Network distribution centers 12 are via optical circuits. Connections from regional centers of each of the service providers, telephone 10, Internet Service Provider 11, and CATV 12 are typically provided through national/international optical networks, 19, 21, and 22 respectively.

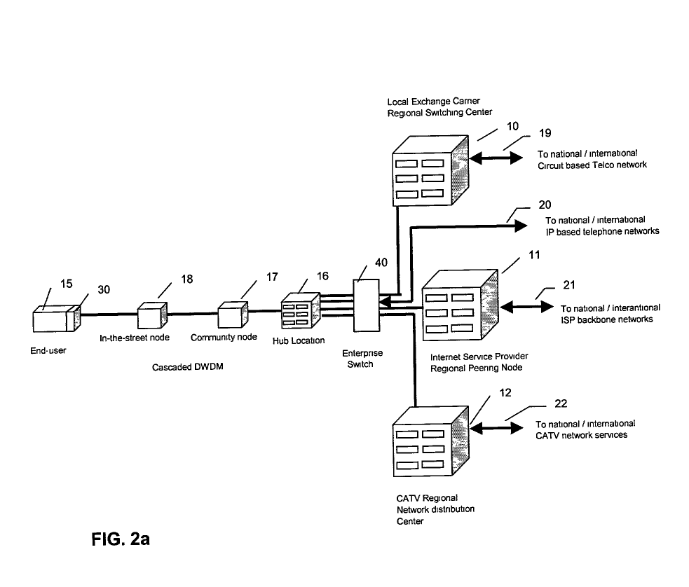

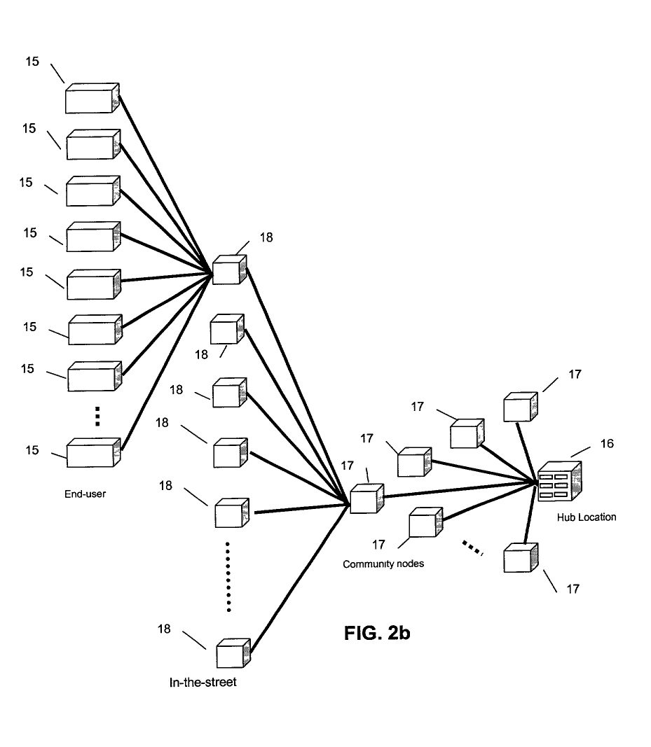

FIG. 2a is a schematic diagram of a end-user network connection, being served by the present invention. A typical end-user 15 will be served by a single fiber or a fiber pair that delivers two-way connections for the combined services including video, telephone, Internet and monitoring and alarm services. For redundancy purposes, two fibers may be deployed between the end-user 15 and the in-the-street node 18 with each having the capability to provide two-way services.

In this arrangement, the end-user fiber will terminate in an in-the-street node 18 that serves to multiplex and de-multiplex signals from end-users 15. The in-the-street node will be constructed in increments of typically 25 port modules, with space in the enclosure for incremental expansions of 4, 8 or 10 such modules, serving 100, 200 or 250 end-user from each in-the-street node. The distance between the end-user 15 and the in-the-street concentration node 18 is typically between 0 and 5 miles. The up-stream side of the in-the-street 18 node will be a single fiber (typically two for redundancy) that carries the signals to the next level concentration node that is a community concentration point 17.

The community concentration node 17 will typically serve a town or community, and will accommodate typically up to 20 twenty in-the-street port modules for a total of typically 500 end-users, each with a two-way bandwidth capacity of typically 2 Gb/s. Additional capacity may be added by increasing the number of community concentrators 17 and/or the number of in the street concentration nodes 18. The up-stream side of the community node 17 will be a single fiber (typically two for redundancy) that carries the signals to the next level concentration node that is the hub concentration point 16. The distance between the community concentration node 17 and the hub 16 can be between five and twenty miles.

The hub concentration node 16 will typically concentrate signals from several towns or communities, serving up to 20 five hundred-port nodes in a single hub 16 for a total of up to 10,000 end-users. Scaling up to accommodate greater numbers of end-users can be accomplished by increasing the number of 10,000 end-user systems, with no technical upper limit.

The hub concentrator node 16 will typically serve as the location where all of the end-user bandwidth channels of a greater metropolitan come together, in a star network configuration. At the hub concentration node 16, the traffic associated with the services of each of the end-users is multiplexed and de-multiplexed, and directed to and from third party services providers, which will typically include local and long distance telephone services 10, video services 12, Internet 11 and end-user monitoring and alarm services. An enterprise bandwidth switch 40 with multi-protocol capabilities will be configured to accommodate up to 10,000 end-users for each star network and will provide the interface to the primary services providers. The interface to the service providers through the bandwidth switch will accommodate circuit switched telephone, Internet Protocol telephony, Internet Protocols and industry standard video. The high levels of bandwidths that can be delivered through this invention make possible a host of new services that can be developed that will create many new markets and new industries, such as multi-gigabit Internet connections, video-on-demand (down loading a full length, HDTV movie in less than 10 seconds), always-on video, voice, monitoring and alarm services and high-resolution packet based video telephony. For business, applications can include the ongoing development of high data rate networked super computers and the creation of virtual office suites that are permanently connected with always on live video connections, even though the offices may geographically separated locally, nationally or globally.

The all-optic network of the present invention is protocol independent, and the end-user gateway equipment 30 and bandwidth switching systems 16 will contain the networking protocol systems specific to each of the service providers.

In an application of the present invention, the bandwidth that will be available to end-users is in the range of typically 2.0 GHz, which with existing art, can be modulated to provide data rates of 1 to 6 Gb/s before compression algorithms are applied. These levels of bandwidth are now typically utilized in the long distance transmission networks and are currently not available at affordable prices from conventional public telephone companies or cable TV companies, primarily because copper or coaxial-based infrastructure does not support such bandwidths for dedicated end-user use. Inherent in the all-optic network design of the present invention is the ability of the all-optic network to co-exist with the copper and coaxial local loop systems, and to facilitate a seamless transition from the legacy copper and coaxial based technology to the present invention's all-optical networks. This is accomplished through network protocol translators that are contained within the enterprise bandwidth switch 40 that interface between packet based services on optical networks with legacy circuit based protocols at the hub locations. In this arrangement, an end-user on the present inventions all-optic network using IP addressing can communicate with an end-user located next door or in another country that utilizes the pulse or tone based signaling services of the legacy phone company.

From a services provider prospective, this invention's local optical bandwidth distribution business model is similar to the distribution methodology now used for the delivery of electric power, whereby a single utility is responsible for the delivery of electrical power to the end-users, but the generation of power is delegated to competitive regional generation utilities. Though networks to provide telecommunications services and the related switching and networking are more complex than distribution networks for electrical power and they requires more intelligent and sophisticated systems to manage, switch and meter the telecommunications services, such switching, management and metering systems currently exist and are available and complimentary to the present invention. Given the similarities between delivering electric power and optical based bandwidths, the body of state and federal regulations governing power distribution could be expanded to serve as the model for distribution end-user optical bandwidth over a single shared network as well, with significant technological and economic benefit to the end-users. As there is no economic justification for multiple electrical distribution networks connecting to a single end-user, with the advanced bandwidth delivery capability of the present invention, there is also no economic or technical justification for the continued practice of having multiple costly and inefficient low bandwidth telecommunications networks serving an end-user.

FIG. 2(b) is schematic diagram of the multi-functional integrated passive optic, fiber based system serving end-users, showing all elements between typical end-users locations 15 and the central hub location 16. The network is a star configuration with two dedicated wavelengths for each end-user, one typically in the “C” band for hub to end-user traffic and one typically in the “L” band for end-user to hub traffic. Based upon the use of Raman amplifiers and the laser power combining methodologies described below, the present invention will allow utilizing wavelengths that are currently outside of the L, C and S bandwidth windows currently in use, taking advantage of the optical spectrum between 488 and 2000 nm. The spokes of the star consist of dedicated fiber between the end-user location 15 and the in-the-street node 18 and utilized shared fiber with channels derived from distributed, holographic DWDM modules located in-the-street-nodes 18 and at the hub location 16. The three cascade configuration of the example design could be expanded to four or even five cascaded nodes, should a specific layout require such a configuration, since the insertion loss of each element of the holographic DWDM is less that 0.2 dB and the node is anticipated to be less than 0.75 dB.

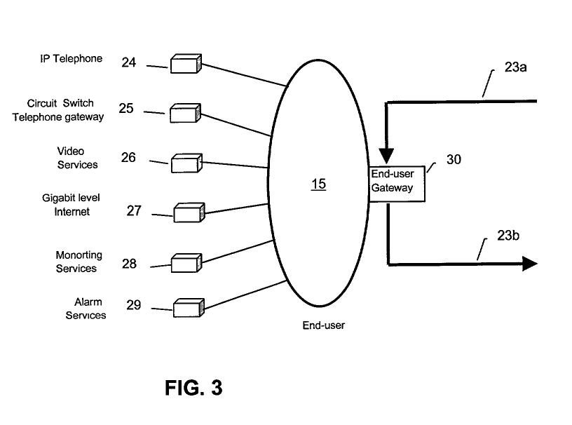

FIG. 3 is a schematic diagram of a typical end-user network configuration 15, consisting of a photodiode detector to convert the optical signal to an electrical signal and an optical modulator used to transform the end-user electrical signals to optical signals, a function of the end-user gateway system. The present invention will provide a total optically-based bandwidth solution for the end-user, that can serve the multiple services that are now obtained from several separate and independent service providers, including telephone, CATV and Internet Service provider. Though the bandwidth for each of these services is carried over a common two-way fiber optic facility, they are logically separate and utilize virtual circuit concepts to maintain their functional separation. Through existing IP-to-circuit switching gateways currently available, the introduction and implementation of the all-optic networking of this invention will be seamless to current legacy system users. At the end-user side, electronic interfaces accept industry standard inputs and deliver signals to end-user devices and systems. The bandwidth allocation to the end-user is typically 2 GHz in both directions, which may be modulated at data rates of 1 to 2 Gb/s with current art technology such as NRZ modulation or significantly higher with more complex modulation, dependent upon the industry standard modulation technique used. This end-user specific bandwidth is shared by the multiple services, using an industry standard protocol, such as 10/100/1000 Ethernet, which may include Internet Protocol (IP) based telephone 24, circuit switched telephony through IP gateways 25, spooling and interactive video services 26, high data rate Internet 27, monitoring 28 and alarm services 29. Industry standard end user gateways 30 contain the multiple protocol conversions that are required to interface to the various services. The transmission system is protocol independent, and carries information such as typically a modulated 1 GHz optical signal between the end-user gateway 15 and the hub node 16. The connection from the in-the-street node 18 and the end-user gateway 30 is via a dedicated fiber 23a and from the end-user gateway to the in-the-street node 18 is via a dedicated return fiber 23b. It should be noted that a single fiber could be used for both directions, however for purposes of redundancy and simplified design, the embodiment shown is preferred. The design shown is for a configuration that requires modulation power only at the end-user location, as pump power is provided from the hub location source to serve as the carrier for the end-user transmission. The configuration can also utilize end-user laser power provided through traditional means with local stored power to continue service during commercial power failures.

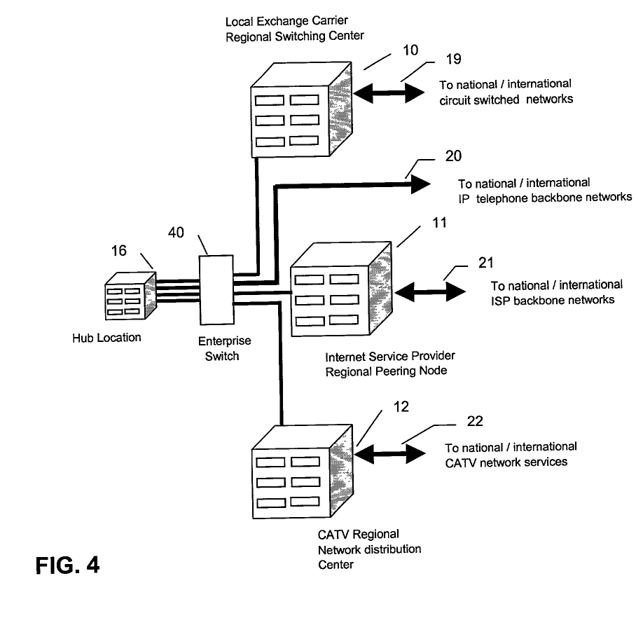

FIG. 4 is a schematic diagram of a typical hub location, depicting the DWDM multiplexing/de-multiplexing site 16, the enterprise class bandwidth switch 40 which uses current art and may be provided by third parties, and high capacity optical connections to the legacy circuit based telephone switching systems 10, the IP based telephone networks 20, the Internet service providers networks through peering nodes 11, and CATV regional and national networks each major video service providers distribution hubs 12. The end-user network interface exiting from the DWDM network 16 and connecting to the enterprise bandwidth switch 40 is discrete channels of typically 2 Gb/s. In effect, the end-user network appears as an optical extension cord, bringing the signals from each end-user's remotely located gateway system 15 to a port on the enterprise class bandwidth switch 40. In this arrangement, individual end-user gateway systems are managed and controlled by a commercially available enterprise class bandwidth switch 40. The enterprise bandwidth switch 40 will serve at the interface between each end-user gateway via an IP/circuit switch translator capability 40, through the appropriate protocol such as Gigabit Ethernet, and the service provider networks 10, 11, 20, and 12 and will make the appropriate optical cross connects. Connections through the enterprise bandwidth switch 40 are permanent virtual connections and end-user services are “always on”. With this arrangement, every end-user will have the choice to dynamically select any programming and service provider for any of the services offered, which will be implemented through software control and will not require any physical modifications to the end-user network that delivers the services. This arrangement provides the ultimate in open network architecture, as it separates the network delivery services from programming content and delivery for all end-user services.

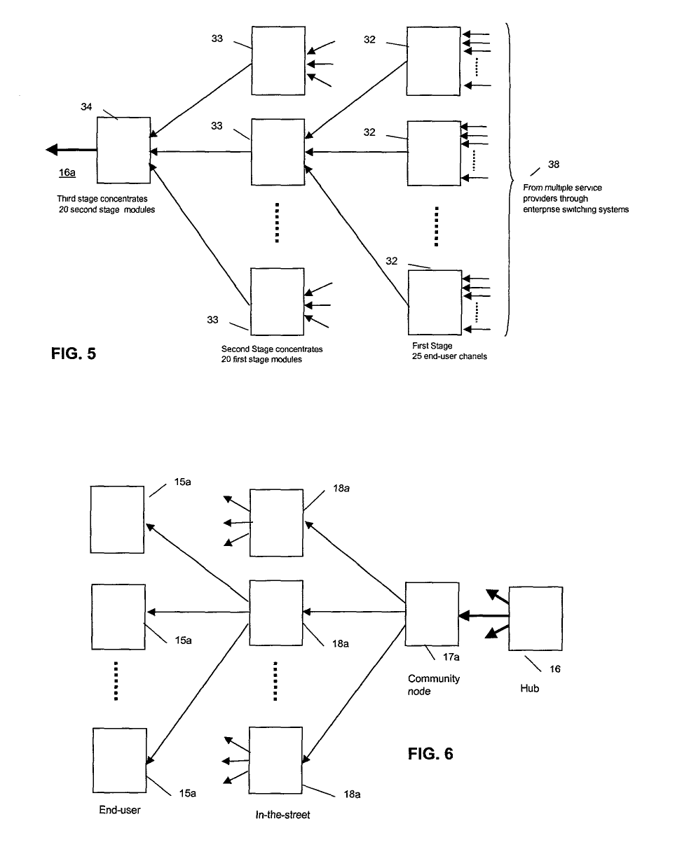

FIG. 5 is a schematic diagram of the cascaded holographic multiplexing system located in the hub 16. A typical configuration is shown with 25 channels received from service providers at 38 with a bandwidth of 2 Ghz each at the first stage 32, that feeds into a second stage of 20 channels with a bandwidth of 50 Ghz each 33, that feeds into a third stage of 20 channels each with a bandwidth of 1 THz each 34. The bandwidth of output port of the third stage 34 is 20 THz. In this arrangement, the optical input signals of 10,000 end-users containing composite signals relating to the individual end-users gateway will be packetized with a transmission protocol such as gigabit Ethernet, for is delivery to the end-user gateway 15.

FIG. 6 is a schematic diagram of the cascaded holographic de-multiplexing system located in the end-user serving area. The distribution arrangement shown is for the delivery of optical signals from the hub location 16 to the end-users 15. The 20 THz output signal from the third stage of the multiplexer 34 is delivered to the first stage of the holographic de-multiplexer 17a, which is in near proximity to the multiplexer, and is also in the hub location 16. The three stages of the de-multiplexer are a mirror image of the hub based multiplexer, but the elements of stages two 17a and three 18a are geographically separated and distributed, interconnected via the end-user fiber network.

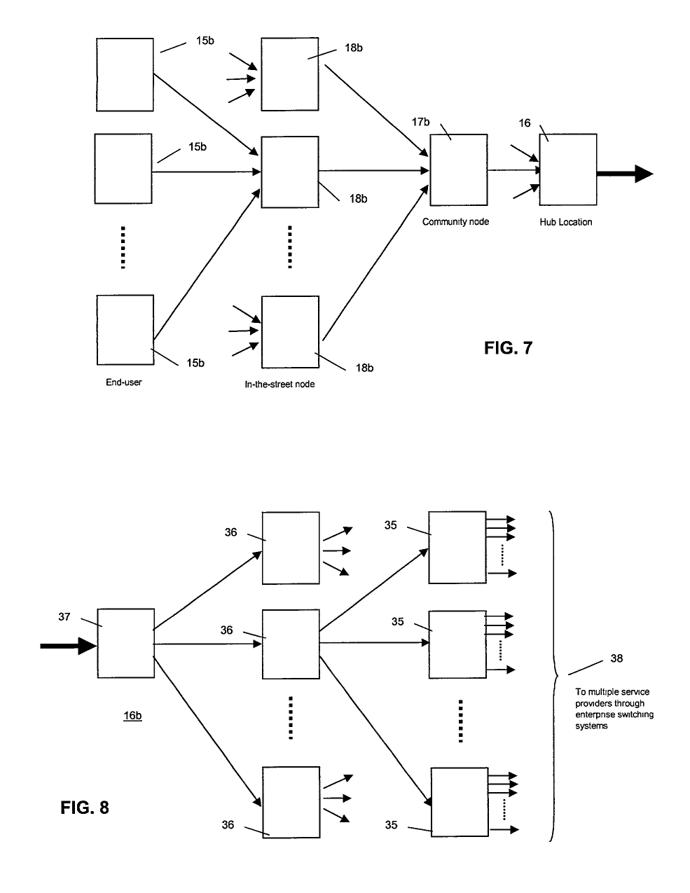

FIG. 7 is a schematic diagram of the cascaded holographic multiplexing system located in the end-user serving area The concentration arrangement shown is the collection of optical signals originating at the end-user locations 15b, for delivery back to the hub location 16. The second stage of the distributed multiplexing system 18b is a mirror image of the second stage of the de-multiplexing system 18a and the third stage of the distributed multiplexing system 17b is a mirror image of the de-multiplexing system 17a.

FIG. 8 is a schematic diagram of the cascaded holographic de-multiplexing system 16b located in the hub 16. In this arrangement, 2 Ghz optical signals are delivered from each of the 10,000 end-users, to the enterprise class bandwidth switch 40 for processing and re-direction to the various content provider services 10, 11, 12 and 20.

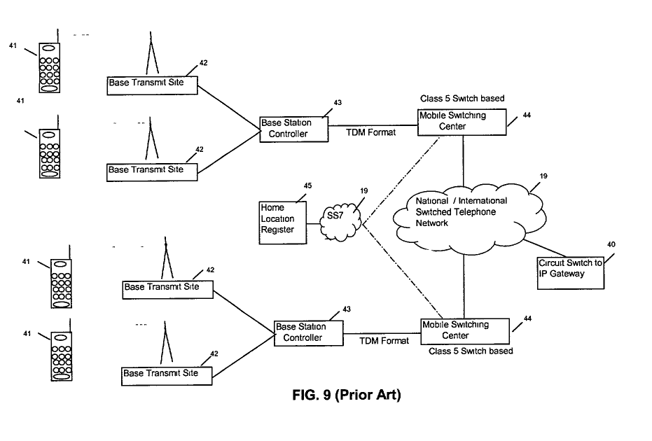

FIG. 9 is a schematic diagram of prior art showing a wireless network utilizing land telephone networking technology to interconnect the base transmit sites 42 to mobile switching centers 43. This is a historic network configuration showing the wireless connections between the mobile phone 41 and the base transmit site 42 where RF signals are converted to conventional telephone TDM channels, using DS0, T1, DS3 and SONET based technology. The base transmit site 42 is connected to a base station controller 43, which base transmit site 42 and mobile switching center 44 monitor and supervise the mobile traffic within the base control area and affecting hand-offs between base transmit sites 42 based on signal strength of the mobile units 41. Mobile switching centers 44 monitor and manage the traffic of their geographical area and complete and receive the calls between the mobiles operating in their area and other national and international areas, using the traditional long distance infrastructure for land based voice traffic. Through the SS7 signaling network 19, mobiles 41 are tracked through a home location register 45, that keeps track of all mobiles 41 that signal to base transmit stations to report their area of location when they are powered on. Interfaces to IP-based land and mobile phones is accomplished through a circuit switch to IP gateway 40 that served both land based and mobile phones.

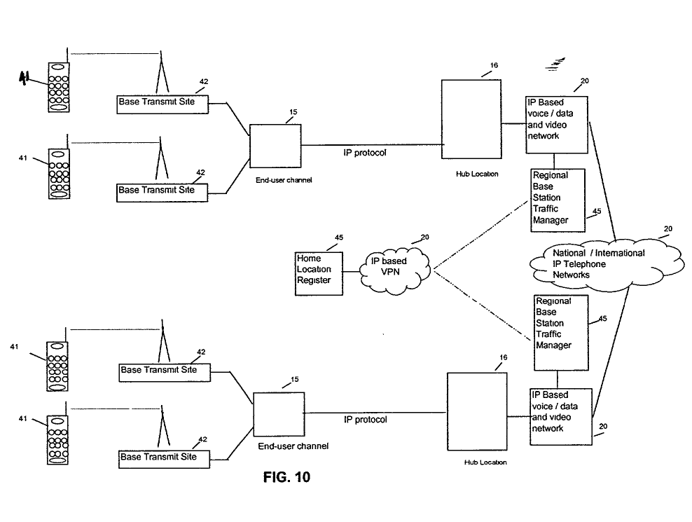

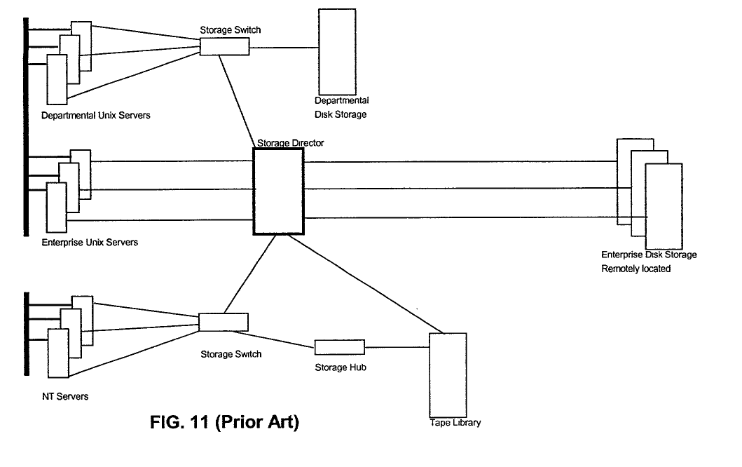

FIG. 10 is a schematic diagram of all-optic core network with dedicated wavelength per cell site using star network configuration. In this network arrangement, the base transmit sites 42 are served by all-optic fiber connections from the in-the-street DWDM module 18 of this inventions passive network. In this application, the end-user 15 is the base transmit site 42, and it can be one of the channels that are derived from the in-the-street mux 18b/demux 18a module (FIGS. 6 and 7), eliminating the need to have a dedicated system to serve mobile base stations, as is currently required. In this arrangement, a bandwidth of from 2 to 10 GHz is delivered to the base transmit site 42 via a dedicated wavelength and a second return wavelength is dedicated for the return traffic. Wider bandwidth can be provided by allocating 2 or more wavelengths, or by providing a wider channel through the multiplexer. The dedicated channels are carried back to the hub location 16, where they are handed off to the regional base station traffic manager 45 via IP-based network 20. The network provides optical channels between the end-points, and the transmission protocol is supplied by the base station traffic manager 45. Each mobile terminal 41 may be allocated a bandwidth of from 2 to 100 Mb/s, in support of 3G and 4G mobile RF bandwidths. This network configuration greatly simplifies the management of mobiles; since all traffic is consolidated on a regional basis and distributed mobile switching centers are eliminated. As mobile traffic may originate and terminate as IP voice traffic, it can be carried directly on national and international IP networks 20, and take full benefit from low cost IP based national and international telephone networks. Since the cost to provide a fiber connection to a base station, along with multi-gigabits of bandwidth, is the same as the cost to serve a residential user, estimated to be less than $100 per month and the network elements are identical, the present invention will provide a superior method for increasing bandwidth available for mobile base stations and at the same time have a significant impact on reducing the cost for mobile service.

FIG. 11 is a schematic diagram of prior art showing a typical major company storage area network configuration utilizing enterprise disk storage. Because of distance limitations of current storage transmission protocols, such as Fiber-channel, high data rate information transfer between host computers and remotely located storage has not kept pace with data transfer developments of other sectors. The state-of-the-art in storage networks is in storage directors, which are complex protocol converters and translators that do not address the basic problem of several storage networking standards that are incompatible with each other.

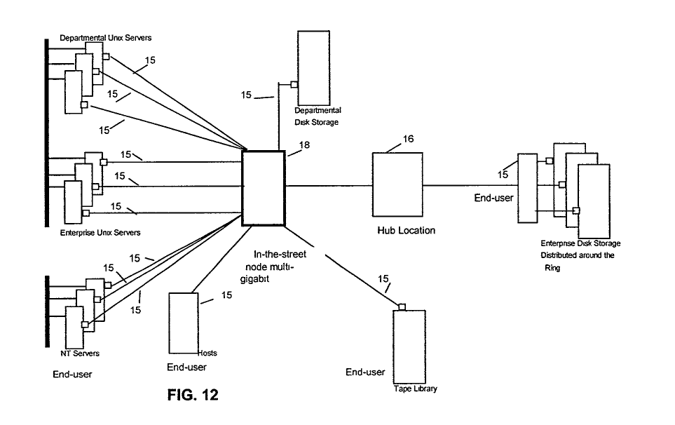

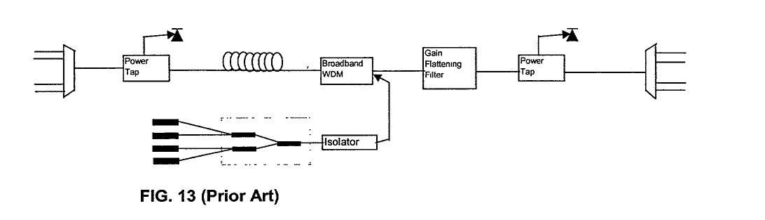

FIG. 12 is a schematic diagram of a all-optic network storage area network configuration utilizing remotely located enterprise disk storage in accordance with the present invention. With the present invention, optical fibers are connected directly to host sites and server locations, providing multi-gigabit data rates to each location 15 via dedicated wavelengths. The storage applications may be served via the same network that is serving residential or business end-users 15, by simply providing connections from the in-the-street-nodes 18 and the storage servers at end-user locations 15 or other storage devices or host computers. The optical wavelengths are consolidated at the hub location 16, where virtual networks may be configured and/or the optical channels may be extended to other geographical areas via national or international bandwidth providers. As the present invention is protocol agnostic, end-users may utilize protocols that best suit their requirements.

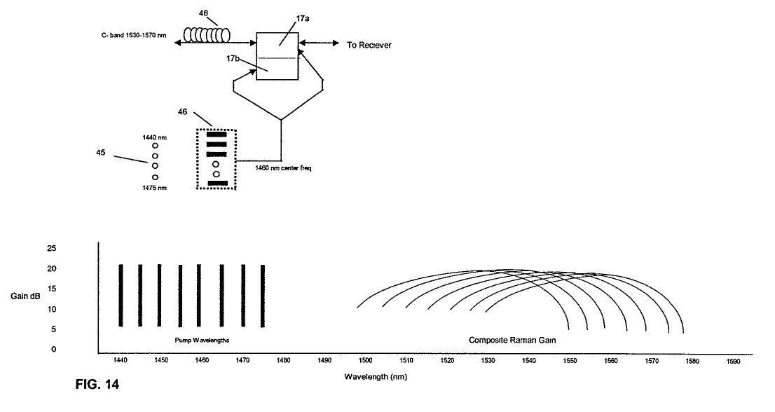

FIG. 13 is a schematic diagram of prior art showing a Raman amplifier pump power arrangement. Current art using methods, such as blazed gratings-based beam combining will limit the number of laser sources 46 to 6, based on wavelength separations on the order of 1 nm and the pumping window of 6 nm.

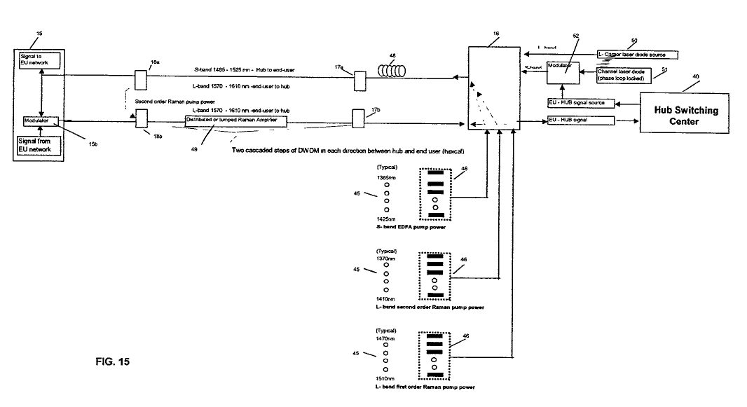

FIG. 14 is a schematic diagram of a networking arrangement for powering Raman amplifier with multiple pump wavelengths to effect wide gain in one and both directions in accordance with the present invention. The laser diode sources 45 are combined through a holographic beam combiner arrangement 46 and directed in two paths, to two faces of a holographic beam combiner that is written to be bi-directional 17a, 17b that will direct the power both upstream and downstream. The selection of the appropriate Raman amplifier frequencies, through methods shown in FIG. 15 and FIG. 17 and described below, provides the ability to insert pump laser power at multiple bandwidths into the same holographic beam combiner unit.

FIG. 15 is a schematic diagram of a networking arrangement for powering Raman amplifier remotely, with pump wavelengths in the S and L bands, for applications such as fiber-to-the-home. This arrangement allows the pump power sources and the per end-user channel laser diodes for both hub to the end-user and end-user to the hub to be centrally located, eliminating the need for power within the distribution system. The distance between the hub and end-user can be typically 25 miles, depending upon final network design considerations. This powering arrangement is designed to work with high channel capacity distributed DWDM networks as shown in FIG. 2(b), with distributed or lumped Raman amplifiers 49 inserted at the first concentration points 18b in the FTTEU network. In this arrangement, the powering scheme is shown for both EDFA 48 and Raman amplifiers 49, however, Raman amplifiers alone could be utilized, thus avoiding the narrow band pass capabilities of EDFA devices. In this arrangement, hub-to-end-user traffic is sent using the S band and/or C band and end-user-to-hub traffic is sent using the L band. The L band channel laser sources are located at the hub 50, and sent as an unmodulated carrier to the end-user location 15 along with the modulated S and/or C band signal 52 destined for the end-user 15. Modulation at 52 for the end-user's signals are provided by the various service providers, directed through the hub switching systems 40. At the end-user location 15, the L channel unmodulated carrier loops to the modulator unit 15b, where it is modulated using end-user generated signals derived from end-user supplied equipment, and passes back to the first DWDM concentration location 18b, and from there back to the hub location 16 for processing. The fiber connection between the end-user location and the first DWDM mux/de-mux location can be via two fibers or via a single fiber.

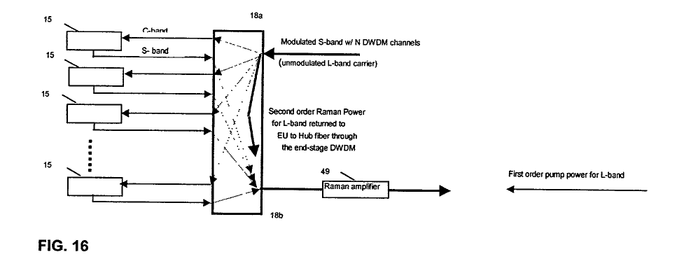

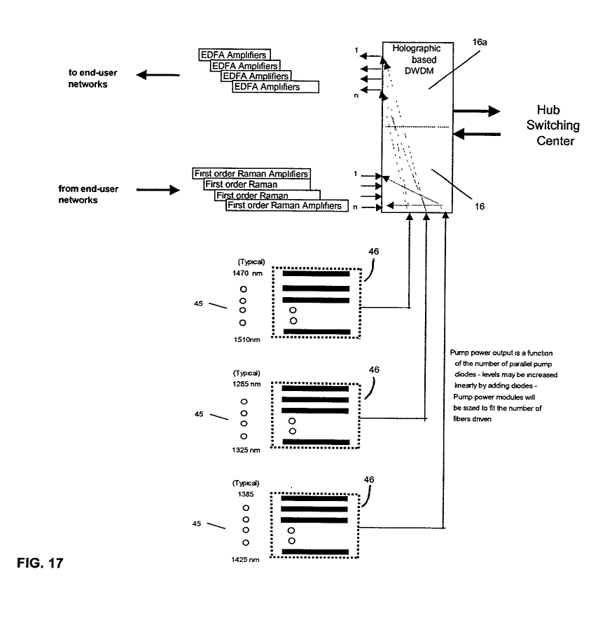

FIG. 16 is a schematic diagram of a networking arrangement for delivering second and first order Raman amplifier pump power to the remote end of a fiber facility for fiber-to-the-end-user applications. In this illustration, the path of the second order pump power for the Raman amplifier is shown within the de-mux 18a/mux 18b where it is directed back out to the return path, either a separate return fiber or the same single fiber, depending upon the deployment. This illustration also shows the arrangement for serving multiple end-user locations (typically 20) from this location, utilizing the single Raman amplifier to serve the multiple end users. Depending upon the distance between the end-user locations, either a single Raman amplifier arrangement may be utilized at the first mux/de-mux locations 18 or a second such arrangement can be implemented at the next mux/de-mux locations 17 to maintain sufficient signal strength to maintain system integrity.

FIG. 17 is a schematic diagram of a pump power delivery system serving multiple fibers at multiple power bands over a common facility driving EDFA and Raman amplifiers. For major installations that will require several, typically 10,000 channel systems, to serve a major metropolitan area, multiple star networks can be deployed, reusing the channel wavelength assignments that are assigned to an individual system. By utilizing holographic beam combining technology to combine laser sources with outputs of several watts, or tens of watts or hundred of watts, for both pump power and individual channel carrier power, economies can be realized in constructing, operating and controlling the power sources. For example, phase locking a high power laser source that can serve several fibers requires the same system as a single channel, single fiber system. Creating banks of laser power of many wavelengths can be equated to a more simplistic example of a phone company maintaining large banks of battery power to the local distribution phone network. The arrangement shown in this figure shows high capacity power laser sources 45 that are constructed using multiple low power sources and combined through a holographic beam combiner 46. The combined outputs are then directed to a holographic beam combiner 16a, 16b configured as part of the fiber to the end-user distribution network, that is serving multiple 10,000 channel star networks. The pump power derived from a common source is then directed to several 10,000-channel networks through the holographic beam combiner system designed to direct the bands of pump power. A similar arrangement can be used for each of the channel sources, for both hub to end-user as well as end-user to hub service.

An all-optic 2-way fiber network for the delivery of signals to and from end-users at data rates up to the maximum rate of the capacity of the fiber, currently in the range of is 20 THz. The system is all-optic, comprised of dedicated fiber from the end-user to the first multiplexing/de-multiplexing node, and shared fiber from the first node to the central hub location. This design is a star network, with dedicated wavelengths to each end-user, utilizing a physical tree fiber distribution system with holographic mux/de-mux units at each branch of the tree. The composite signals carried between the end-user locations and the central hub location serve multiple applications, including but not limited to video, voice, Internet and specific monitoring, alarm and management services. The novel design includes the high number of channels that can be carried on a single fiber, the centrally located network powering scheme and the distributed multiplexing and de-multiplexing arrangement used to accomplish the star design implemented through a tree all-fiber network. Equipment at the end-user locations, known as home gateways, separates the signals and provides the interface to industry standard terminal devices such as digital TV sets, computer network interface cards, local area networks, IP telephony systems and IP/circuit based telephony conversion systems. At the hub locations, the composite signal of each user is separated and service specific signals are directed to application service provider systems that include video, Internet, IP telephony, circuit switched telephone, mobile phone service, storage networks, monitoring and alarm services and management services. At the hub the signal processing is done through one or more enterprise class metropolitan switches, capable of translating between the current legacy protocols of the various service providers

The present invention provides the network design and technical solution for creating all-fiber end-user networks that could be built and managed by a single network utility, on the model of the current electrical power distribution utilities, with end-user services provided by competitive service providers. The bandwidth management and allocation performed at the hub location could be provided by the end-user network utility or by an independent service provider. Content and services can then be provided by competitive service providers that deliver their services through the metropolitan switching utility. This business model is now being implemented on an ad-hoc basis in several countries including Canada, Sweden, and Holland and major municipalities such as Chicago and Calgary but without benefit of a global system design and a regulatory structure in place to take full advantage of the benefits that could be achieved.

Although this invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for delivering optical channels of bandwidths in the general range of from 2 to 5 GHz, with channel spacing of from 0.01 to 0.03 nm, to and from a central hub and multiple end-user locations at a distance of typically up to 25 miles, utilizing a system consisting of a holographic-based dense wave division multiplexer/demultiplexer module that is configured in a distributed, cascaded arrangement of two or more stages, the cascaded modules deployed between the central hub location and the end-user location, that utilizes a an optical tree fiber network configured as a logical star network permanently connecting one or more dedicated unique wavelength for each end-user at the points of the star.

2. The method of claim 1 further comprising constructing the optical tree network with a modular distributed dense wave division multiplexer system configured to carry typically 10,000 multi-gigabit channels to and from a hub location, using L, C, S bands and spectrum outside of the conventional ITU bands, with the cascaded modules of a distributed DWDM located at each branch of the tree, connected by fibers that carry multiple channels between the hub location and a second cascaded dense wave division multiplexer module, a next fiber segment connecting the second and a third cascaded dense wave division multiplexer module and a dedicated fiber or fiber pair between the third stage and the end-user, carrying at least two wavelengths to the end-user.

3. The method of claim 2, further comprising delivering nominally up to 10,000 wavelengths to and from up to 10,000 end-user locations within a radius of approximately 25 miles, comprising low insertion loss dense wave division multiplexer cascaded network modules, having narrow channel spacing of a high channel count stage of the mux/de-mux module and an optical feed back system to lock channel power laser sources.

4. The method of claim 3, further comprising collecting and distributing optical traffic in a geographical local service area utilizing dedicated wavelengths for each of a plurality of end-users, and providing bandwidths of nominally 2.0 to 5 GHz, by performing one of modulation from 1 Gb/s up to 5 Gb/s, using non-return-to zero modulation and up to 10 Gb/s using bandwidth efficient modulation.

5. A method for configuring an access network consisting of a high channel capacity star network with a dedicated wavelength delivered to each of a plurality of end-users at points of the star, implemented over an all-optical fiber tree configuration with distributed dense wave division multiplexer modules located at each branch of the tree, the network serving as an optical local loop distribution network, to accommodate delivery of all telecommunications services between a central hub location and end-users within a radius of typically 25 miles.

6. An improved optical local network comprising strategically located endpoints to form virtual optical networks for purposes of serving multi-gigabit data rate channels for carrying IP or other transport protocol-based mobile base station traffic, dropping and inserting mobile traffic bandwidth to serve wireless base transmit sites that are dispersed throughout the end-user serving area, utilizing similar systems as are residential end-users or business end-users, and appear as virtual private networks.

7. The improved optical local network of claim 6 for carrying geographically dispersed servers, disks and automated tape libraries for purposes of transferring files for storage

8. An improved method for generating and delivering pump power for Raman and Erbium Doped Fiber amplifiers, through combining laser power sources through a holographic beam combiner, combining power on the same wavelengths or on a family of dissimilar wavelengths to achieve “flat” power profiles of desired output levels, and delivering the power to a fiber transmission facility through ports on the same DWDM systems that carry information channels.

9. An improved method for generating and delivering channel carrier laser power to a fiber transmission facility, through holographic power combining techniques.

10. An improved method for creating large laser power combining facilities, to be used on multiple fibers for multiple star network configurations, both as pump power sources and as shared per channel power sources.

11. An improved method for providing carrier laser power to an end-user location, from a central hub location.

12. An improved method for providing first and second order power to a Raman amplifier located in the return path of a fiber transmission facility, serving multiple end-users through a shared Raman amplifier facility.

13. An optical transmission system comprising:
a plurality of service provider systems providing transmission-based services;
a plurality of end-user devices receiving transmission-based services;
a central hub node including a first plurality of terminals for supporting bidirectional transmission of optical signals between said plurality of service provider systems and said central hub node and a second plurality of terminals for supporting bidirectional transmission of optical signals between said end-user devices and said central hub node;
a first transmission network coupled between said plurality of service provider systems and said plurality of first terminals of said central hub node for enabling said bidirectional transmission of optical signals between said plurality of service provider systems and said plurality of first terminals of said central hub node; and
a second transmission network coupled between said plurality of end-user devices and said plurality of second terminals of said central hub node for enabling said bidirectional transmission of optical signals between said plurality of end-user devices and said plurality of first terminals of said central hub node;
wherein said bi-directional optical transmission between each of said plurality of end-user devices and said central hub node occurs at a dedicated wavelength that is unique to each end-user device.

14. The system of claim 13 wherein said second transmission network comprises a demultiplexer system for demultiplexing each optical signal transmitted from said plurality of second terminals of said central hub node into a plurality of said dedicated wavelength optical signals unique to each of said plurality of end-user devices.

15. The system of claim 14 wherein said second transmission network comprises a multiplexer system for multiplexing each of said plurality of said dedicated wavelength optical signals unique to each of said plurality of end-user devices to optical signals transmitted to said plurality of second terminals of said central hub node.

16. The system of claim 15 wherein said transmission-based services provided by said plurality of service providers include at least one of telephone services, video broadcast services, internet services and data transmission services.

17. The system of claim 16 wherein each of said end-user devices comprises one of a home and business, each including a conversion device for converting said dedicated wavelength optical signal to an electrical signal which utilized by a data device associated with said one of a home and business.

18. The system of claim 17 wherein each conversion device further converts electrical signals from said data device to optical signals having said dedicated wavelength for transmission to said central hub node.

19. The system of claim 18 wherein said second transmission network comprises at least one intermediate node between said central hub node and said plurality of end-user devices.

20. The system of claim 19 wherein said at least one intermediate node includes a first node located approximately 0 to 5 miles from each end-user device and a second node located between said first node and said central hub node and wherein said central hub node is located up to 25 miles from each end-user device.

21. The system of claim 13 wherein said bi-directional transmission of optical signals between said plurality of end-user devices and said plurality of first terminals of said central hub node occurs in a bandwidth having a range of approximately 2 GHz to 10 GHz.

22. The system of claim 13 wherein said central hub node includes a power pump for providing power to said first and second transmission networks.
